(19) United States
(12) Patent Application Publication
(10) Pub. No.: US 2015/0247733 A1
(43) Pub. Date: Sep. 3, 2015

(54) MAP INFORMATION PROCESSING DEVICE AND STORAGE MEDIUM

(71) Applicant: DENSO CORPORATION, Kariya-city, Aichi (JP)

(72) Inventor: Satoshi Horihata, Nagoya-city (JP)

(21) Appl. No.: 14/431,514

(22) PCT Filed: Sep. 26, 2013
(86) PCT No.: PCT/JP2013/005698

§ 371 Date: Mar. 26, 2015

(30) Foreign Application Priority Data
Oct. 5, 2012 (JP) 2012-223433

(51) Int. Cl. G01C 21/34; G01S 19/42

(52) U.S. Cl. CPC G01C 21/34; G01S 19/42

(57) ABSTRACT

In a map information processing device, a travel route data is generated to include a reception condition data indicating whether the GPS signals are received or not when the present position deviates from a subject road included in the road data. When the generated travel route data includes the reception condition data indicating an absence of a reception of the GPS signals, a travel route is determined whether to pass through a high-rise building area. When the travel route is determined to not pass through a high-rise building area, a property of the travel route is set as tunnel.

### CROSS REFERENCE TO RELATED APPLICATION

This application is based on Japanese Patent Application No. 2012-223433 filed on Oct. 5, 2012, the disclosure of which is incorporated herein by reference.

### TECHNICAL FIELD

The present disclosure relates to a map information processing device that adds road information of a new road to a map data when a vehicle travels the new road, and a storage medium including instructions for adding road information of a new road to a map data.

### BACKGROUND ART

A vehicle navigation system includes a map data including road data and background data, and uses the map data to display a vehicle position and searches for and gives guidance on a route to a destination. However, in some cases, road data of a newly constructed road has not been included in the map data.

Travel route data of the vehicle is compared with the map data in order to detect a new road and add road data of the detected new road to the map data. In Patent Literature 1, a road property, such as a parking lot, a tunnel, an underpass, or a bridge is set as the road data of the new road and the road data of the new road is added to the map data for the sake of users' convenience.

In Patent Literature 1, while a GPS signal is not being received, a property of tunnel is set in a road data of the new road. However, when the property is set to the tunnel as mentioned above, a problem may arise. When a vehicle travels along a new road that is parallel to an elevated road in a high-rise building area where GPS signals are difficult to reach, a property of the new road may be erroneously set as the tunnel.

In Patent Literature 1, when a GPS signal is not received and travel route data of the vehicle overlaps with a background data of the map data, which indicate a railroad, a property of the new road is set as underpass in a new road data. However, when a vehicle travels along a new road overlapping with a subway in a high-rise building area, a property of the new road may be erroneously set as underpass.

In Patent Literature 1, when an average speed between a start point and an end point in travel route data is equal to or less than a predetermined threshold value, a property of the new road is set as a parking lot in a new road data. However, in some parking lots of large-scale shopping mall or the like, vehicles may travel at the same speed as on ordinary roads. In this case, a property of parking lot may not be set as the parking lot.

### PRIOR ART LITERATURES

### Patent Literature

Patent Literature 1: JP-A-2011-154404

### SUMMARY OF INVENTION

In view of the foregoing difficulties, it is an object of the present disclosure to provide a map information processing device that is able to more correctly set a property of a new road that is travelled by a vehicle, and a storage medium that includes instructions for setting a property of a new road more correctly.

According to a first aspect of the present disclosure, a map information processing device includes a storage unit, a GPS receiver, a self-contained navigation sensor, a position calculation unit, a comparison unit, a generation unit, a high-rise building area determination unit, and a property setting unit. The storage unit stores a map data including a plurality of road data and a plurality of background data. Each of the plurality of road data includes a position and a property of each of a plurality of roads. The GPS receiver receives a plurality of GPS signals from a global positioning system (GPS) satellite and detects an absolute position of a vehicle. The self-contained navigation sensor detects a relative position of the vehicle. The position calculation unit calculates a present position of the vehicle with reference to the absolute position detected by the GPS receiver and the relative position detected by the self-contained navigation sensor. The comparison unit compares the plurality of road data with the present position of the vehicle, which is calculated by the position calculation unit. The comparison unit further determines whether the present position of the vehicle deviates from a subject road by longer than a predetermined distance. The subject road is indicated by one of the plurality of road data. The generation unit generates a travel route data indicating a travel route travelled by the vehicle with reference to the present position of the vehicle when the comparison unit determines that the present position of the vehicle deviates from the subject road by longer than the predetermined distance. The generation unit generates the travel route data to include a reception condition data indicating whether the GPS signals are received by the GPS receiver. The high-rise building area determination unit determines whether the travel route passes through a high-rise building area with reference to the map data stored in the storage unit and the travel route data when the travel route data includes the reception condition data indicating an absence of a reception of the GPS signals. The property setting unit sets a property of the travel route data as a tunnel when the high-rise building area determination unit determines that the travel route does not pass through the high-rise building area.

With above device, a road property can be correctly set to a new road that is travelled by a vehicle.

According to a second aspect of the present disclosure, a non-transitory tangible computer readable storage medium stores a program product including instructions to be executed by a computer. The instructions for implementing functions of the position calculation unit, the comparison unit, the generation unit, the high-rise building area determination unit, and the property setting unit of the map information processing device according to the first aspect of the present disclosure. The map information processing device is provided by a portable terminal device, and the instructions are installed in the portable terminal device.

With above storage medium, a road property can be correctly set to a new road that is travelled by a vehicle.

According to a third aspect of the present disclosure, a map information processing device includes a storage unit, a GPS receiver, a self-contained navigation sensor, a position calculation unit, a comparison unit, a generation unit, an overlap determination unit, and a property setting unit. The storage unit stores a map data including a plurality of road data and a plurality of background data. Each of the plurality of road data includes a position and a property of each of a plurality of roads, and the plurality of background data includes a position and an altitude of each of a plurality of railroads. The GPS receiver receives a plurality of GPS signals from a global positioning system (GPS) satellite and detects an absolute position of a vehicle. The self-contained navigation sensor detects a relative position of the vehicle. The position calculation unit calculates a present position of the vehicle with reference to the absolute position of the vehicle detected by the GPS receiver and the relative position of the vehicle detected by the self-contained navigation sensor. The comparison unit comparing the plurality of road data with the present position of the vehicle, which is calculated by the position calculation unit. The comparison unit further determines whether the present position of the vehicle deviates from a subject road by longer than a predetermined distance. The subject road is indicated by one of the plurality of road data. The generation unit generates a travel route data indicating a travel route travelled by the vehicle with reference to the present position of the vehicle when the comparison unit determines that the present position of the vehicle deviates from the subject road by longer than the predetermined distance. The generation unit generates the travel route data to include a reception condition data indicating whether the GPS signals are received by the GPS receiver. The overlap determination unit determines whether the travel route overlaps with an underground railroad with reference to the map data stored in the storage unit and the travel route data when the travel route data includes the reception condition data indicating an absence of a reception of the GPS signals. The underground railroad is one of the plurality of railroads and is located underground. The property setting unit sets a property of the travel route data as an underpass when the overlap determination unit determines that the travel route does not overlap with the underground railroad.

With above device, a road property can be correctly set to a new road that is travelled by a vehicle.

According to a fourth aspect of the present disclosure, a non-transitory tangible computer readable storage medium stores a program product including instructions to be executed by a computer. The instructions for implementing functions of the position calculation unit, the comparison unit, the generation unit, the overlap determination unit, and the property setting unit of the map information processing device according to the third aspect of the present disclosure. The map information processing device is provided by a portable terminal device, and the instructions are installed in the portable terminal device.

With above storage medium, a road property can be correctly set to a new road that is travelled by a vehicle.

According to a fifth aspect of the present disclosure, a map information processing device includes a storage unit, a GPS receiver, a self-contained navigation sensor, a position calculation unit, a slope calculation unit, a comparison unit, a generation unit, an underpass determination unit, and a property setting unit. The storage unit stores a map data including a plurality of road data. Each of the plurality of road data includes a position, an altitude, and a property of each of a plurality of roads. The GPS receiver receives a plurality of GPS signals from a global positioning system (GPS) satellite and detecting an absolute position of a vehicle. The self-contained navigation sensor detects a relative position of the vehicle. The position calculation unit calculates a present position of the vehicle with reference to the absolute position detected by the GPS receiver and the relative position detected by the self-contained navigation sensor. The slope calculation unit calculates a slope of a road corresponding to a travel route travelled by the vehicle. The comparison unit compares the plurality of road data with the present position of the vehicle, which is calculated by the position calculation unit. The comparison unit further determines whether the present position of the vehicle deviates from a subject road by longer than a predetermined distance. The subject road is indicated by one of the plurality of road data. The generation unit generates a travel route data indicating the travel route with reference to the present position of the vehicle when the comparison unit determines that the present position of the vehicle deviates from the subject road by longer than the predetermined distance. The generation unit generates the travel route data to include a reception condition data indicating whether the GPS signals are received by the GPS receiver and a slope data that indicates the slope of the road corresponding to the travel route. When the travel route data includes the reception condition data indicating an absence of a reception of the GPS signals, the underpass determination unit acquires an altitude of a start point and an altitude of an end point of the road corresponding to the travel route from the plurality of road data stored in the storage unit, and determines whether the travel route is an underpass with reference to the altitude of the start point and the altitude of the end point of the road corresponding to the travel route and the slope data, which is included in the travel route data and indicates the slope of the road corresponding to the travel route. The property setting unit sets a property of the travel route data as an underpass when the underpass determination unit determines that the travel route is the underpass.

With above device, a road property can be correctly set to a new road that is travelled by a vehicle.

According to a sixth aspect of the present disclosure, a non-transitory tangible computer readable storage medium stores a program product including instructions to be executed by a computer. The instructions for implementing functions of the position calculation unit, the slope calculation unit, the comparison unit, the generation unit, the underpass determination unit, and the property setting unit of the map information processing device according to the fifth aspect of the present disclosure. The map information processing device is provided by a portable terminal device, and the instructions are installed in the portable terminal device.

With above storage medium, a road property can be correctly set to a new road that is travelled by a vehicle.

According to a seventh aspect of the present disclosure, a map information processing device includes a storage unit, a position calculation unit, a comparison unit, a generation unit, a vehicle determination unit, and a property setting unit. The storage unit stores a map data including a plurality of road data. Each of the plurality of road data includes a position and a property of each of a plurality of roads. The position calculation unit calculates a present position of a vehicle. The comparison unit compares the plurality of road data with the present position of the vehicle, which is calculated by the position calculation unit. The comparison unit further determines whether the present position of the vehicle deviates from a subject road by longer than a predetermined distance. The subject road is indicated by one of the plurality of road data The generation unit generates a travel route data indicating a travel route travelled by the vehicle with reference to the present position of the vehicle when the comparison unit determines that the present position of the vehicle deviates from the subject road by longer than the predetermined distance. When the comparison unit determines that the present position of the vehicle deviates from the subject road by longer than the predetermined distance, the vehicle determination unit determines whether a state of a start switch of the vehicle is changed during a travel of the vehicle from a start point to an end point of the travel route and further determines whether a shift position of a transmission of the vehicle is turned to a reverse position during the travel of the vehicle from the start point to the end point of the travel route. The property setting unit sets a property of the travel route data as a parking lot when the vehicle determination unit determines that the state of the start switch is changed and the shift position of the transmission of the vehicle is turned to the reverse position.

With above device, a road property can be correctly set to a new road that is travelled by a vehicle.

According to an eighth aspect of the present disclosure, a non-transitory tangible computer readable storage medium stores a program product including instructions to be executed by a computer. The instructions for implementing functions of the position calculation unit, the comparison unit, the generation unit, the vehicle determination unit, and the property setting unit of the map information processing device according to the seventh aspect of the present disclosure. The map information processing device is provided by a portable terminal device, and the instructions are installed in the portable terminal device.

With above storage medium, a road property can be correctly set to a new road that is travelled by a vehicle.

### BRIEF DESCRIPTION OF DRAWINGS

The above and other objects, features, and advantages of the present disclosure will become more apparent from the following detailed description made with reference to the accompanying drawings. In the drawings:

FIG. 1 is a block diagram showing a configuration of a vehicular navigation system according to an embodiment of the present disclosure;

FIG. 2 is a flowchart showing a process for adding a new road according to a first embodiment of the present disclosure;

FIG. 3 is a flowchart showing a subroutine process for generating a travel route data;

FIG. 4 is a flowchart showing a subroutine process for determining whether an object is a tunnel or not;

FIG. 5 is a flowchart showing a process for adding a new road according to a second embodiment of the present disclosure;

FIG. 6 is a flowchart showing a subroutine process for determining whether an object is an underpass or not;

FIG. 7 is a flowchart showing a process for adding a new road according to a third embodiment of the present disclosure;

FIG. 8 is a flowchart showing a subroutine process for determining whether an object is an underpass or not;

FIG. 9 is a flowchart showing a process for adding a new road according to a fourth embodiment of the present disclosure;

FIG. 10 is a flowchart showing a subroutine process for generating a travel route data; and

FIG. 11 is a flowchart showing a subroutine process for determining whether an object is a parking lot or not.

### EMBODIMENTS FOR CARRYING OUT INVENTION

Hereafter, a description will be given to each embodiment in which a map information processing device according to the present disclosure is applied to a vehicular navigation system with reference to the drawings.

### First Embodiment

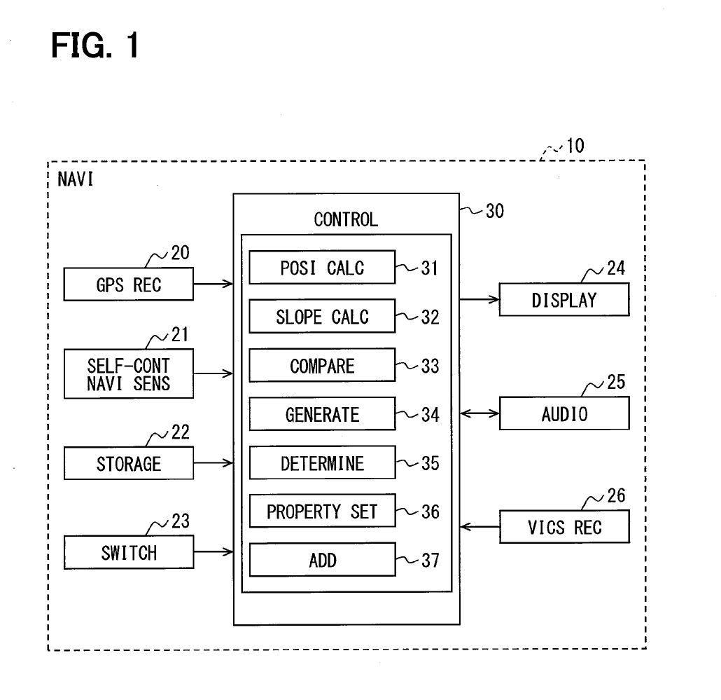

FIG. 1 illustrates a configuration of a navigation system (NAVI) 10. A map information processing device according to the first embodiment of the present disclosure is applied to the navigation system 10. The navigation system 10 determines whether a new road is a tunnel or not and adds new road data to a map data. The navigation system 10 includes: a global positioning system (GPS) receiver (GPS REC) 20, a self-contained navigation sensor (SELF-CONT NAVI SENS) 21, a storage device (STORAGE) 22, an operation switch group (SWITCH) 23, a display device (DISPLAY) 24, an audio input output device (AUDIO) 25, a VICS (registered trademark) receiver (VICS REC) 26, and a controller (CONTROL) 30.

The GPS receiver 20 receives GPS signals transmitted from GPS satellites and detects an absolute position and an absolute orientation of a vehicle. The present position of the vehicle detected by the GPS receiver 20 and a strength of the GPS signals received by the GPS receiver 20 are sent to the controller 30.

The self-contained navigation sensor 21 includes a gyro scope, a vehicle speed sensor, and an acceleration sensor. The gyro scope is a vibration-type gyro having a vibrator as a main part. Coliolis force generated in accordance with the angular velocity of a rotary motion is applied to the vibrator of the gyro, and an angular velocity of the vehicle is detected by the vibrator during a turning of the vehicle. The vehicle speed sensor detects a traveling speed of the vehicle based on vehicle speed pulses sent from the vehicle each time when the vehicle travels a predetermined distance. The acceleration sensor detects an acceleration of the vehicle which is applied in a traveling direction of the vehicle. The self-contained navigation sensor 21 detects the position of the vehicle with respect to a predetermined initialization position as a relative position based on the above-mentioned angular velocity, traveling speed, and the acceleration of the vehicle. The self-contained navigation sensor 21 sends the detected relative position of the vehicle to the controller 30.

The storage device 22 includes a DVD device, a hard disk device, or the like and stores map data. The map data includes a header, road data, background data, and character data. The road data includes multiple node data each of which has longitude and latitude information and indicates a node, such as an intersection. The road data further includes multiple link data each of which connects two node data and indicates a road between two nodes. The link data has a road property indicating a property of a road, altitude, and the like associated with the link data. The background data includes data for defining a background of the map. The background data is correlated with a type, shape coordinates, altitude, and the like. The type of the background data includes railroad, green area, river, sea, parking lot, condominium, facility, and the like. The character data includes data indicating characters to be displayed on the map. The header includes information, such as a location and a size of the road data, background data, and character data, a version of the map data, or the like.

The operation switch group 23 includes a mechanical key switch provided in the instrument panel of the vehicle and a touch switch integrated with the display device 24. The operation switch group 23 may be provided in a remote control terminal, which is not shown. The operation switch group 23 is operated by a user to input a departure point, a destination, and the like, and outputs a command signal corresponding to the operation made by the user to the controller 30.

The display device 24 is provided by a liquid crystal display, an organic EL (Electro Luminescence) display, a plasma display, or the like.

The display device 24 is positioned in the vehicle compartment at a position so that the display device is viewable by the user. The display device 24 provides the user with the present location of the vehicle on a map, route guidance from the present location to a destination, and the like.

The audio input output device 25 outputs voice guidance, through a speaker, for guiding various facilities in map data and various notifications. The audio input output device 25 converts a speech, which is made by the user and is inputted through a microphone, into an electrical signal and outputs the electric signal to the controller 30. Thus the user can operate the navigation system 10 by inputting a voice instruction to the microphone, similar to the operation made to the operation switch group 23.

The VICS receiver 26 acquires road traffic information such as traffic jam information and traffic control information from a VICS information center in real time through FM multiplex broadcasting or through an optical beacon or a radio beacon installed on a roadside.

The controller 30 is a general purpose microcomputer that includes CPU, ROM and RAM, and an input output device. The ROM stores a computer program that is to be executed for providing functions of a position calculation unit (POSI CALC) 31, a slope calculation unit (SLOPE CALC) 32, a comparison unit (COMPARE) 33, a generation unit (GENERATE) 34, a determination unit (DETERMINE) 35, a property setting unit (PROPERTY SET) 36, and an adding unit (ADD) 37. The CPU executes the computer program stored in the ROM, and functions as the position calculation unit 31, the slope calculation unit 32, the comparison unit 33, the generation unit 34, the determination unit 35, the property setting unit 36, and the adding unit 37.

When the controller 30 receives a departure point and a destination from the operation switch group 23 or from the audio input output device 25, the controller 30 calculates a route from the departure point to the destination based on the map data read out from the storage device 22. Then, the controller 30 sends the calculated route to the display device 24.

The position calculation unit 31 calculates the coordinates of the present position of the vehicle based on at least one of the absolute position of the vehicle, the absolute orientation of the vehicle, or the relative position of the vehicle. Herein, the absolute position and the absolute orientation of the vehicle are detected by the GPS receiver 20. The relative position of the vehicle is detected by the self-contained navigation sensor 21 based on the angular velocity and traveling speed of the vehicle. Hereafter, the coordinates of the present position of the vehicle is also be referred to as the present position of the vehicle.

The slope calculation unit 32 calculates a slope of a road along which the vehicle is travelling. There are two methods for calculating the slope of a road. The two methods include a method using the gyro scope and a method using the vehicle speed sensor. In the method using the gyro scope, a gyro scope is equipped to the vehicle for sensing a rotation of the vehicle in a roll direction of the vehicle and another gyro scope is equipped to the vehicle for sensing a rotation of the vehicle in a pitch direction of the vehicle. Alternatively, a 3D gyro scope may be equipped to the vehicle so that the 3D gyro scope is able to sense a rotation of the vehicle both in the roll direction and in the pitch direction. By detecting an amount of the rotation of the vehicle in the pitch direction, the slope of the road along which the vehicle is travelling is detected.

In the method using the vehicle speed sensor, the slope of the road is detected as described below. The traveling direction component (obtained by taking the sine of gravitational acceleration) of gravitational acceleration applied to the vertical direction of the vehicle is added to the result obtained by differentiating a vehicle speed detected by the vehicle speed sensor. The result of this addition is equivalent to the acceleration in the vehicle traveling direction detected by the acceleration sensor. Therefore, the sine of gravitational acceleration can be obtained by subtracting the result obtained by differentiating the vehicle speed detected by the vehicle speed sensor from the acceleration detected by the acceleration sensor. Since the gravitational acceleration is a known parameter, the slope of the road can be obtained from the sine of gravitational acceleration.

The slope calculation unit 32 calculates the slope of the road along which the vehicle is travelling by weighting and averaging the slope of the road acquired by the method using the gyro scope and the slope of the road acquired by the method using the vehicle speed sensor.

The comparison unit 33 compares the road data read out from the storage device 22 with the present position calculated by the position calculation unit 31. Then, the comparison unit 33 determines whether the present position deviates from a subject road indicated by one corresponding road data by longer than a predetermined distance. The comparison unit 33 increases the predetermined distance with a reduction of a strength of the GPS signal received by the GPS receiver 20 and maximize the predetermined distance when a GPS signal is not received by the GPS receiver 20. When a GPS signal is not received by the GPS receiver 20, the comparison unit 33 determines whether the relative position of the vehicle deviates from the subject road indicated by the corresponding road data by longer than the predetermined distance. Herein, the relative position of the vehicle is calculated based on the angular velocity and traveling speed of the vehicle detected by the self-contained navigation sensor 21.

The generation unit 34 generates the travel route data based on the present position of the vehicle when the present position of the vehicle deviates from a subject road indicated by the corresponding road data by longer than the predetermined distance. The travel route data indicates a travel route travelled by the vehicle and includes data indicating a slope of the travel route calculated by the slope calculation unit 32 and data indicating whether a GPS signal is received by the GPS receiver 20. Hereafter, data indicating the presence or absence of reception of a GPS signal is also be referred to as reception condition data.

When the travel route data generated by the generation unit 34 includes data indicating the absence of the reception of a GPS signal, the determination unit 35 reads out background data stored in the storage device 22 and determines whether a road indicated by the travel route of the vehicle is a road passing through a high-rise building area. The determination unit 35 functions as a high-rise building area determination unit.

The property setting unit 36 sets a property of the travel route data as a tunnel when the determination unit 35 determines that the road indicated by the travel route of the vehicle does not pass through a high-rise building area.

The adding unit 37 adds the travel route data of the vehicle to the map data stored in the storage device 22 as a new road data.

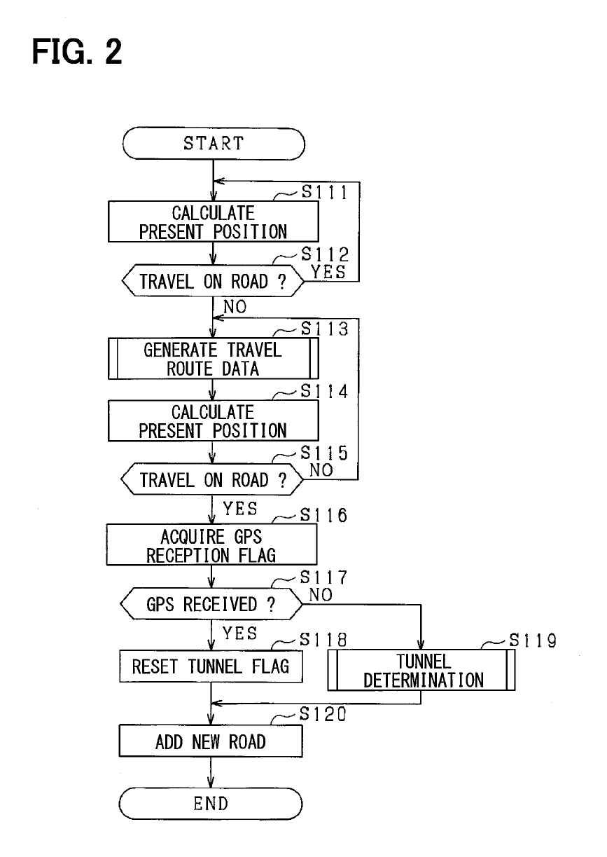

The following will describe a process executed by the navigation system 10 for adding a new road. FIG. 2 is a flowchart showing a process executed by the navigation system 10 for adding a new road.

At S111, the position calculation unit 31 calculates the present position of the vehicle. At S112, the comparison unit 33 determines whether the vehicle is travelling along a road indicated by a road data stored in the storage device 22. Specifically, the comparison unit determines whether the present position of the vehicle deviates from a subject road indicated by the corresponding road data stored in the storage device 22 by longer than a predetermined distance. When the comparison unit 33 determines that the present position does not deviate from the road indicated by the road data stored in the storage device 22 by longer than the predetermined distance, the comparison unit determines that the vehicle is travelling along the road (YES). Then, the process returns to S111. Then, S111 and S112 are repeatedly executed.

When the comparison unit 33 determines at S112 that the present position of the vehicle deviates from the subject road indicated by the corresponding road data stored in the storage device 22 by longer than the predetermined distance, that is, the comparison unit 33 determines that the vehicle is not travelling along the road indicated by the road data stored in the storage device 22 (NO), the comparison is able to determine that the vehicle is travelling along a new road. At S113, the generation unit 34 generates a travel route data indicating a travel route of the vehicle. Process executed at S113 will be described in detail later.

At S114, the position calculation unit 31 calculates the present position of the vehicle similar to S111. At S115, the comparison unit 33 determines whether the vehicle is travelling along a road indicated by a road data stored in the storage device 22 similar to S112. When the comparison unit 33 determines at S115 that the vehicle is not travelling along the road indicated by the road data stored in the storage device 22, that is, the vehicle has not returned to an existing road stored in the map data (NO), the process returns to S113. Then S113 to S115 are repeatedly executed.

When the comparison unit 33 determines at S115 that the vehicle is travelling along a road indicated by the road data stored in the storage device 22 (YES), the comparison unit determines that the vehicle has returned from a new road back to the existing road stored in map data. Then the process for adding a new road data to the map data is activated.

At S116, the controller acquires a GPS reception flag from the travel route data generated by the generation unit 34. Herein, the GPS reception flag is a data indicating whether a GPS signal is received by the GPS receiver 20 or not.

At S117, based on the GPS reception flag acquired at S6, the controller determines whether the GPS signal is received in all of the sections of the new road. When the controller determines at S117 that the GPS signal is received in all of the sections of the new road (YES), the controller determines that that new road does not include a tunnel section. At S118, the controller resets a tunnel flag. The tunnel flag is a flag to be added to the travel route data and indicates that the new road is determined to be a tunnel.

At S117, when the controller determines that the GPS signal is not received in some sections of the new road (NO), the controller further determines whether the new road is a tunnel or not at S119. When the new road is determined to be a tunnel, the tunnel flag is added to the travel route data. Process executed at S119 will be described later in detail.

At S120, the controller adds the travel route data to the map data stored in the storage device 22 as a new road data. As a result, road data indicating the new road is added to the map data.

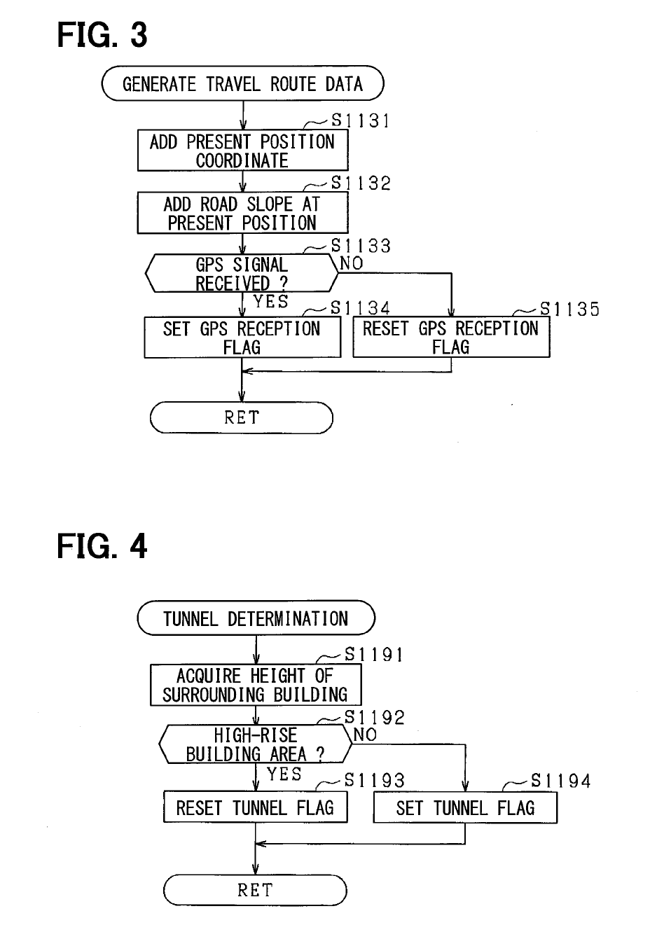

The following will describe a process executed by the generation unit 34 at S113 for generating the travel route data. FIG. 3 shows a subroutine process for generating the travel route data. At S1131, the generation unit 34 adds coordinates of the present position of the vehicle calculated by the position calculation unit 31 to the travel route data. At S1132, the generation unit 34 adds the slope of a new road at the present position to the travel route data. Herein, the slope of the new road is calculated by the slope calculation unit 32.

At S1133, the generation unit 34 determines whether a GPS signal is received by the GPS receiver 20. When a GPS signal is received (YES), the generation unit 34 sets a GPS reception flag at S1134. When a GPS signal is not received (NO), the generation unit 34 resets a GPS reception flag at S1135.

The above-mentioned process generates the travel route data including data indicating a travel route of the vehicle, the slope of the travel route, and data indicating the presence or absence of reception of a GPS signal. Then, the process returns to S114.

The following will describe a tunnel determination process executed at S119. FIG. 4 shows a subroutine process for determining whether a new road is a tunnel or not. A GPS signal may not be received when the vehicle travels through a tunnel or when the vehicle travels along a road in an area bristling with high-rise buildings. Thus, the subroutine process determines whether a travel route indicated by the travel route data extends through a high-rise building area. When the vehicle is travelling along a new road in a high-rise building area, a property of the new road is prevented from being erroneously set as the tunnel.

At S1191, the controller acquires, from the background data stored in the storage device 22, height information of buildings existing in the vicinity of a section of a travel route where a GPS signal was not received. At S1192, the controller determines whether the vicinity of the section of the travel route where the GPS signal was not received is a high-rise building area or not, based on the height information of the buildings acquired at S1191. That is, the controller determines whether the section of the travel route where the GPS signal was not received extends through a high-rise building area. Specifically, when buildings higher than a predetermined height are arranged at a density higher than a predetermined density in the vicinity of a travel route, the controller determines that the area is a high-rise building area.

When the controller determines at S1192 that the travel route extends through the high-rise building area (YES), the controller resets a tunnel flag at S1193. When the vehicle travels through a tunnel in a high-rise building area, a tunnel flag is not set. Since a tunnel rarely exists in a high-rise building area, this does not cause a problem. When the controller determines at S1192 that the travel route does not extend through a high-rise building area (NO), the controller sets a tunnel flag at S1194 in correspondence with a section where the GPS reception flag is not set. Then, the process returns to S120.

The above-described first embodiment provides the following advantages.

A property of the travel route data indicating a new road is set as tunnel only when the vehicle travels along a new road, which is positioned out of high-rise building areas and is unable to receive a GPS signal. Thus, when the vehicle travels along a new road in a high-rise building area and a GPS signal is not received during the travelling, a property of the new road is prevented from being erroneously set as a tunnel within the travel route data indicating the new road. Accordingly, when the vehicle travels along a new road, road data of the new road having a properly set road property can be added to the map data.

The present position calculated based on the absolute position detected by the GPS receiver 20 may deviate from an actual position by a distance and the distance increases with a reduction of the strength of the received GPS signal. Thus, a criterion value (predetermined distance) for determining whether the present position deviates from a subject road indicated by the corresponding road data may be increased with the reduction of the strength of the received GPS signal. Thus, a determination of the road along which the vehicle travels can be prevented from being erroneously determined as a new road even when the vehicle is travelling along a road indicated by the road data stored in the storage device 22.

The map information processing device according to the first embodiment of the present disclosure includes a storage unit 22, a GPS receiver 20, a self-contained navigation sensor 21, a position calculation unit 31, a comparison unit 33, a generation unit 34, a high-rise building area determination unit 35, and a property setting unit 36. The storage unit 22 stores map data, which includes road data and background data. The road data includes a position and a property of each of multiple roads. The GPS receiver 20 receives multiple GPS signals from a GPS satellite and detects the absolute position of the vehicle. The self-contained navigation sensor 21 detects a relative position of the vehicle, The position calculation unit 31 calculates the present position of the vehicle based on the absolute position detected by the GPS receiver 20 and the relative position detected by the self-contained navigation sensor. The comparison unit 33 compares the road data with the present position calculated by the position calculation unit 31, and determines whether the present position deviates from a subject road indicated by a stored road data corresponding to the present position by longer than a predetermined distance. The generation unit 34 generates travel route data indicating a travel route of the vehicle based on the present position when the comparison unit 33 determines that the present position deviates from the subject road by longer than the predetermined distance. The travel route data is generated to include reception condition data indicating whether a GPS signal is received by the GPS receiver 20. The high-rise building area determination unit 35 determines whether a travel route passes through a high-rise building area when the travel route data includes the reception condition data indicating the absence of reception of the GPS signal with reference to the travel route data and the map data stored in the storage unit 22. The property setting unit 36 sets a property of the travel route data as a tunnel when the high-rise building area determination unit 35 determines that the travel route does not pass through a high-rise building area.

The present disclosure may be provided as a program product stored in a non-transitory tangible computer readable storage medium, and the program product may include instructions to be executed by a computer, the instructions for implementing functions of the position calculation unit 31, the comparison unit 33, the generation unit 34, the high-rise building area determination unit 35, and the property setting unit 36 of the map information processing device according to the present embodiment. In this case, the map information processing device may be provided by a portable terminal device, and the instructions are installed in the portable terminal device.

According to the present embodiment, the road data included in the map data is compared with the present position of the vehicle. When the present position is determined to be deviated from a road indicated by the road data by longer than a predetermined distance, the travel route data is generated. The travel route data includes a data indicating a travel route of the vehicle and a data indicating the presence or absence of reception of the GPS signal.

The GPS signal may not be received in a tunnel or in a high-rise building area. When the generated travel route data includes the data indicating the absence of reception of the GPS signal, the travel route of the vehicle is determined whether to pass through a high-rise building area based on the travel route data and the map data. Under a condition that the travel route of the vehicle is determined to not pass through a high-rise building area, a property of the new road is set as tunnel in the travel route data.

According to the present embodiment, a property of the new road is set as tunnel in the travel route data indicating the new road only when the vehicle travels along a new road, which is positioned out of the high-rise building areas and is unable to receive a GPS signal. Thus, when the vehicle travels along a new road in a high-rise building area and a GPS signal is not received during the travelling, a property of the new road is prevented from being erroneously set as a tunnel in the travel route data indicating the new road. Accordingly, when the vehicle travels along a new road, road data of the new road having a properly set road property can be added to the map data.

### Second Embodiment

The following will describe a navigation system 10 according to the second embodiment of the present disclosure specifically about a difference from the navigation system 10 according to the first embodiment. The navigation system 10 according to the second embodiment determines whether a new road is an underpass and adds the new road data to map data.

The determination unit 35 of the navigation system 10 in the second embodiment operates as described below when travel route data generated by the generation unit 34 includes data indicating the absence of reception of the GPS signal. The determination unit 35 reads background data stored in the storage device 22 and determines whether a travel route of the vehicle partially overlaps, that is, intersects with an aboveground railroad. The determination unit 35 functions as an overlap determination unit.

The property setting unit 36 sets a property of the new road as underpass in the travel route data under a condition that the determination unit 35 determines that the travel route of the vehicle does not overlap with an underground railroad.

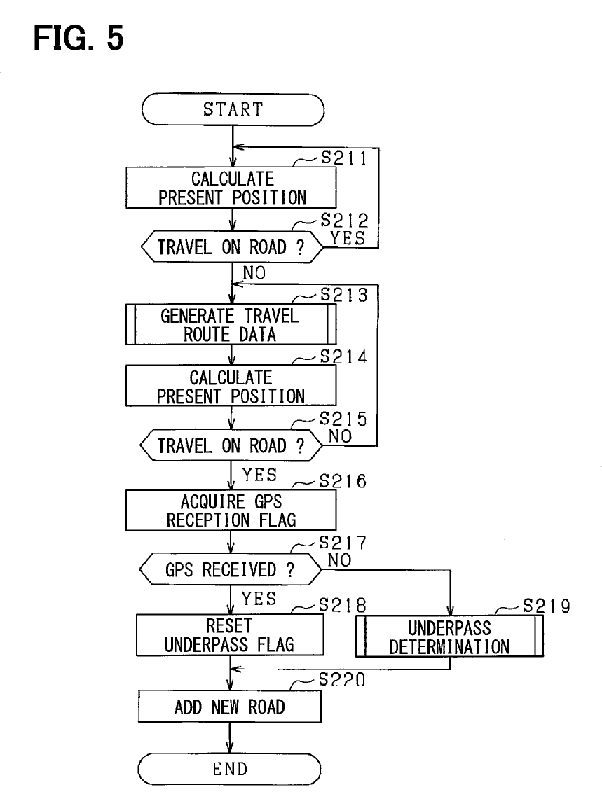

The following will describe a process executed by the navigation system 10 for adding a new road. FIG. 5 is a flowchart showing a process executed by the navigation system 10 for adding a new road.

At S211 to S217, processes similar to the processes of S111 to S117 are carried out by the controller. When the controller determines at S217 that the GPS signal has been received (YES), the controller determines that the new road is not an underpass. At S218, the controller resets an underpass flag. The underpass flag is a flag to be added to the travel route data and indicates that the new road is determined to be an underpass.

When the controller determines at S217 that a GPS signal has not been received (NO), the controller determines at S219 whether the new road is an underpass or not. When the new road is an underpass, the controller sets the underpass flag in the travel route data. The process executed at S219 will be described later in detail.

At S220, the controller adds the travel route data to the map data stored in the storage device 22 as new road data, similar to S120.

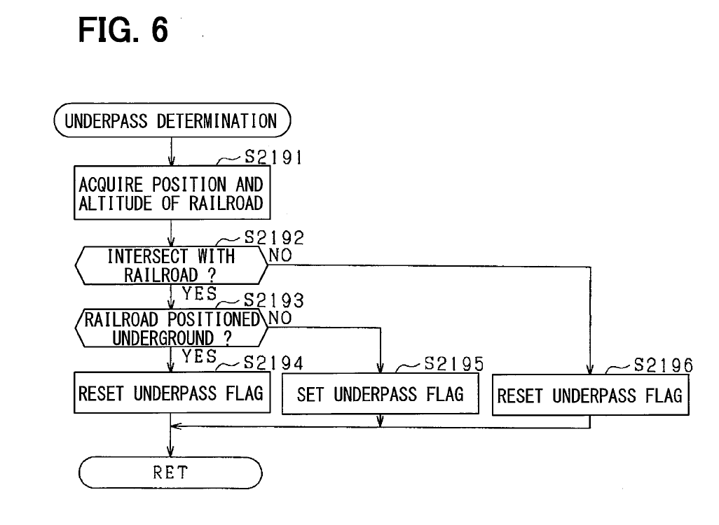

The following will describe a process executed at S219 for determining whether a new road is an underpass or not. FIG. 6 shows a subroutine process for determining whether a new road is an underpass or not. In this subroutine process, the controller determines whether a travel route indicated by the travel route data overlaps with an underground railroad. When the travel route overlaps with an underground railroad, the process prevents an underpass flag from being erroneously set to the new road.

At S2191, the controller acquires information related to the position and altitude of a railroad located in the vicinity of a travel route indicated by the travel route data from the background data stored in the storage device 22.

At S2192, the controller determines whether a section of a travel route, which is unable to receive a GPS signal, overlaps with a railroad. When the controller determines at S2192 that the section of the travel route, which is unable to receive the GPS signal, does not overlap with a railroad (NO), the controller determines that the GPS signal was not received due to a disturbance, such as multipath. Then, the controller resets the underpass flag at S2196.

When the controller determines at S2192 that the section of the travel route, which is unable to receive a GPS signal, overlaps with the railroad (YES), the controller proceeds to S2193. At S2193, the controller determines whether the railroad overlapping with the travel route is positioned underground. When the controller determines at S2193 that the railroad is not positioned underground, that is, the section of the travel route which is unable to receive the GPS signal overlaps with an aboveground railroad (YES), the controller determines that the travel route overlaps with the aboveground railroad. Then, at S2195, the controller sets an underpass flag to the section of the travel route, which the GPS signal reception flag is not set to.

At S2193, when the controller determines that the railroad is positioned underground (YES), the controller determines that a GPS signal was not received due to a disturbance, such as multipath. That is, when the section of the travel route which is unable to receive the GPS signal overlaps with an underground railroad (YES), the controller determines that a GPS signal was not received due to a disturbance, such as multipath. Then at S2194, the controller resets the underpass flag. Then, the process proceeds to S220.

The above-described second embodiment provides the following advantages.

A property of the new road indicated by the travel route data of the vehicle is set to the underpass only when the new road overlaps with an aboveground railroad and at least an intersection segment of the new road with the aboveground railroad is unable to receive the GPS signal. With this configuration, a property of the new road is prevented from being erroneously set as underpass in the travel route data indicating the new road when the vehicle travels along the new road overlapping with an underground railroad and the intersection segment of the new road is unable to receive the GPS signal. Accordingly, when the vehicle travels along a new road, road data of the new road having a properly set road property can be added to the map data.

The map information processing device according to the second embodiment of the present disclosure includes a storage unit 22, a GPS receiver 20, a self-contained navigation sensor 21, a position calculation unit 31, a comparison unit 33, a generation unit 34, an overlap determination unit 35, and a property setting unit 36. The storage unit 22 stores map data, which includes road data and background data The road data includes a position and a property of each of multiple roads. The background data includes a position and an altitude of each of multiple railroads. The GPS receiver 20 receives multiple GPS signals from a GPS satellite, and detects the absolute position of the vehicle. The self-contained navigation sensor 21 detects a relative position of the vehicle. The position calculation unit 31 calculates the present position of the vehicle based on the absolute position detected by the GPS receiver 20 and the relative position detected by the self-contained navigation sensor. The comparison unit 33 compares the road data with the present position calculated by the position calculation unit 31 and determines whether the present position deviates from a subject road indicated by a corresponding road data by longer than a predetermined distance. The generation unit 34 generates a travel route data indicating a travel route of the vehicle based on the present position when the comparison unit 33 determines that the present position deviates from the subject road by longer than the predetermined distance. The travel route data is generated so as to include a reception condition data indicating whether a GPS signal is received by the GPS receiver 20. The overlap determination unit 35 determines whether the travel route overlaps with an underground railroad when the travel route data included in the reception condition data indicates the absence of reception of the GPS signal with reference to the travel route data and the map data stored in the storage unit 22. The underground railroad is one of multiple railroads and is located underground. The property setting unit 36 sets a property of the travel route data as an underpass when the overlap determination unit 35 determines that the travel route overlaps with the underground railroad.

The present disclosure may be provided as a program product stored in a non-transitory tangible computer readable storage medium, and the program product may include instructions to be executed by a computer, the instructions for implementing functions of the position calculation unit 31, the comparison unit 33, the generation unit 34, the overlap determination unit 35, and the property setting unit 36 of the map information processing device according to the present embodiment. In this case, the map information processing device is provided by a portable terminal device, and the instructions are installed in the portable terminal device.

According to the present embodiment, travel route data is generated when the present position is determined to deviate from a road indicated by the road data by longer than a predetermined distance. The travel route data includes data indicating a travel route of the vehicle and a data indicating whether a GPS signal is received. When generated travel route data includes data indicating the absence of reception of a GPS signal, the travel route of the vehicle is determined whether to overlap with an underground railroad with reference to the travel route data and the background data including the position and altitude of the railroad. Then, a property of the travel route is set as the underpass in the travel route data under a condition that the travel route of the vehicle is determined to not overlap with the underground railroad.

According to the present embodiment, a property of the travel road is set as the underpass in the travel route data indicating a new road only when the vehicle travels along the new road overlapping with an aboveground railroad and at least an intersection segment of the new road is unable to receive a GPS signal. Thus, when the vehicle travels along a new road, which overlaps with an underground railroad and is unable to receive a GPS signal, a property of the new road is prevented from being erroneously set as an underpass in the travel route data indicating the new road. Accordingly, when the vehicle travels along a new road, road data of the new road having a properly set road property can be added to the map data.

### Third Embodiment

The following will describe a navigation system 10 according to the third embodiment specifically about difference from the navigation system 10 according to the first embodiment. The navigation system 10 according to the third embodiment determines whether a new road is an underpass and adds a new road data to the map data.

The determination unit 35 of the navigation system 10 in the third embodiment determines whether a travel route of the vehicle is an underpass or not when travel route data generated by the generation unit 34 includes data indicating the absence of reception of a GPS signal. Specifically, the controller determines whether the travel route is an underpass based on the altitudes of a start point and an end point of the travel route and the slope of the travel route included in the travel route data. Herein, the altitudes of the start point and the end point of the travel route are acquired from the storage device 22. Therefore, the determination unit 35 functions as an underpass determination unit.

When the determination unit 35 determines that a travel route of the vehicle is an underpass, the property setting unit 36 sets property of the travel route as the underpass in the travel route data.

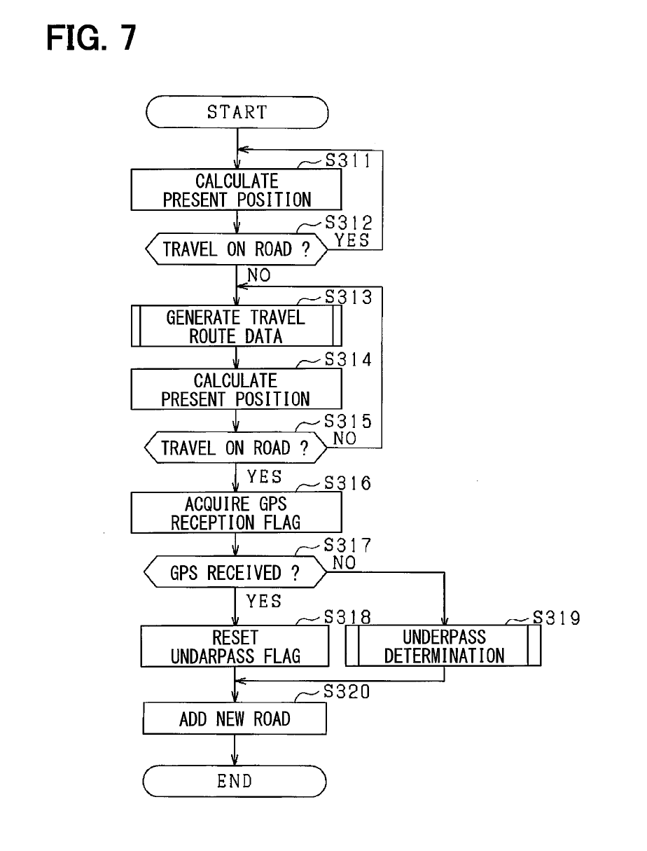

The following will describe a process executed by the navigation system 10 for adding a new road. FIG. 7 is a flowchart showing a process executed by the navigation system for adding a new road.

At S311 to S317, processes similar to the processes of S111 to S117 are carried out by the controller. When the controller determines at S317 that a GPS signal has been received (YES), the controller determines that the new road is not an underpass. At S318, the controller resets an underpass flag. The underpass flag is a flag to be added to the travel route data and indicates that the new road is determined to be an underpass.

When the controller determines at S317 that a GPS signal has not been received (NO), the controller determines at S319 whether the new road is an underpass or not. When the new road is an underpass, the controller sets the underpass flag in the travel route data. The process executed at S319 will be described later in detail.

At S320, the controller adds the travel route data to the map data stored in the storage device 22 as new road data, similar to S120.

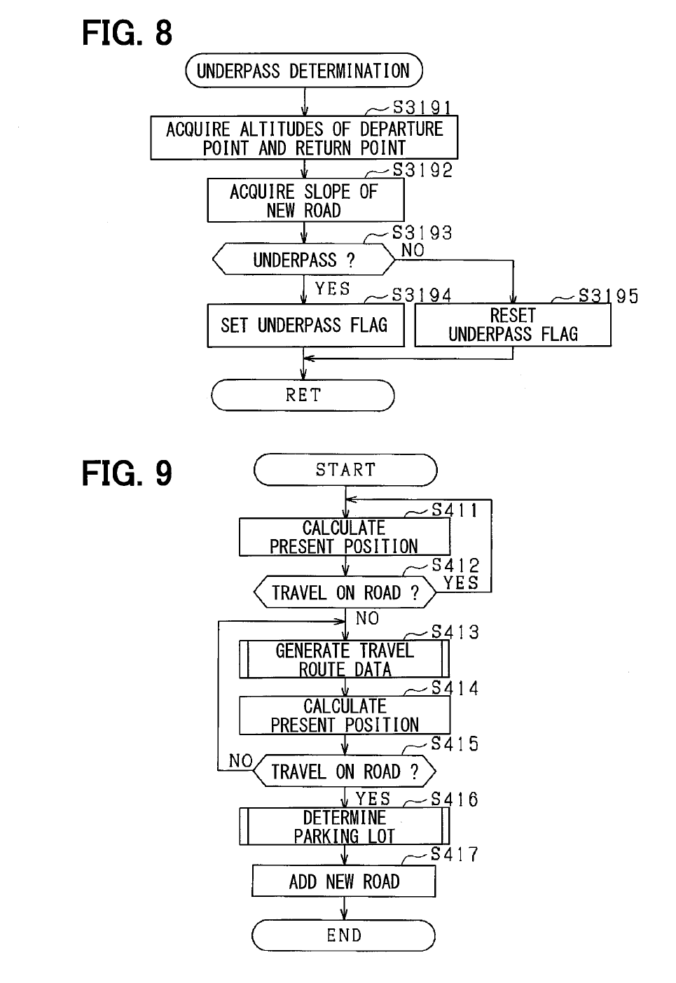

The following will describe a process executed at S19 for determining whether a new road is an underpass or not. FIG. 8 shows a subroutine process for determining whether a new road is an underpass or not. In this subroutine process, the controller calculates a slope shape of the travel route indicated by the travel route data, and determines whether a section of the travel route, which is unable to receive the GPS signal, is an underpass.

At S3191, the controller acquires information of the altitude of a point at which the vehicle departs from a road indicated by the road data and information of the altitude of a point at which the vehicle returns to a road indicated by the road data. That is, the controller acquires information of the altitudes of the start point and the end point of the travel route. The controller acquires the information from the road data stored in the storage device 22.

At S3192, the controller acquires information of the slope of the travel route calculated by the slope calculation unit 32 from the travel route data.

At S3193, the controller determines whether a section of the travel route, which is unable to receive the GPS signal, is an underpass or not with reference to the altitudes of the start point and the end point of the travel route and the slope of the travel route. The altitudes of the start point and the end point of the travel route are acquired from the storage device 22 at

S3191. The slope of the travel route is calculated by the slope calculation unit 32, and is acquired by the controller at S3192. Specifically, the travel route is determined as an underpass when the start point and the end point of the travel route are lower than a predetermined altitude and the vehicle travels downward first and then travels upward during the section, which is defined by the start point and the end point of the travel route.

When the controller determines at S3193 that the travel route is an underpass (YES), the controller sets an underpass flag in correspondence with a section to which a GPS reception flag is not set at S3194. When the controller determines at S3193 that the travel route is not an underpass (NO), the controller resets an underpass flag at S3195. Then, the process returns to S320.

The above-described third embodiment provides the following advantages.

When the vehicle travels along a new road and is unable to receive the GPS signal, the controller determines whether the new road is an underpass based on the altitudes and slope of the travel route. Thus, a short segment of the travel road positioned under the elevated railway can be accurately determined as an underpass. Accordingly, when the vehicle travels along a new road, road data of the new road having a properly set road property can be added to the map data.

The map information processing device according to the third embodiment of the present disclosure includes a storage unit 22, a GPS receiver 20, a self-contained navigation sensor 21, a position calculation unit 31, a slope calculation unit 32, a comparison unit 33, a generation unit 34, an underpass determination unit 35, and a property setting unit 36. The storage unit 22 stores map data including road data. The road data includes a position, an altitude, and a property of each of multiple roads. The GPS receiver 20 receives multiple GPS signals from a GPS satellite, and detects the absolute position of the vehicle. The self-contained navigation sensor 21 detects a relative position of the vehicle. The position calculation unit 31 calculates the present position of the vehicle based on the absolute position detected by the GPS receiver 20 and the relative position detected by the self-contained navigation sensor. The slope calculation unit 32 calculates the slope of a road corresponding to the travel route of the vehicle. The comparison unit 33 compares road data with the present position calculated by the position calculation unit 31, and determines whether the present position of the vehicle deviates from a subject road indicated by a corresponding road data by longer than a predetermined distance. The generation unit 34 generates travel route data indicating a travel route of the vehicle based on the present position when the comparison unit 33 determines that the present position deviates from the subject road by longer than the predetermined distance. The travel route data is generated by including the slope data, which indicates the slope of the road and is calculated by the slope calculation unit 32, and reception condition data indicating whether a GPS signal is received by the GPS receiver 20. The underpass determination unit 35 determines whether a travel route is an underpass when the travel route data includes reception condition data indicating the absence of reception of the GPS signal with reference to the altitude of the start point and the altitude of the end point of the travel route and slope data indicating the slope of the travel road. The altitude of the start point and the altitude of the end point are acquired from the road data stored in the storage unit 22, and the slope data indicating the slope of the travel road is acquired from the travel route data. The property setting unit 36 sets a property of the travel route data as an underpass when the underpass determination unit 35 determines that the travel route is an underpass.

The present disclosure may be provided as a program product stored in a non-transitory tangible computer readable storage medium, and the program product may include instructions to be executed by a computer, the instructions for implementing functions of the position calculation unit 31, the slope calculation unit 32, the comparison unit 33, the generation unit 34, the underpass determination unit 35, and the property setting unit 36 of the map information processing device according to the present embodiment. In this case, the map information processing device is provided by a portable terminal device, and the instructions are installed in the portable terminal device.

According to the present embodiment, travel route data is generated when the present position is determined to deviate from a road indicated by the road data by longer than a predetermined distance. The travel route data includes a data indicating a travel route of the vehicle, a data indicating the slope of the travel route of the vehicle, and a data indicating whether the GPS signal is received. When the generated travel route data includes the data indicating the absence of reception of the GPS signal, the controller determines whether the travel route of the vehicle is an underpass. This determination is made based on the altitudes of the start point and the end point of the travel route of the vehicle and the slope of the travel route of the vehicle. Then, the controller sets a property of the travel route as an underpass in the travel route data under a condition that the travel route of the vehicle is determined as an underpass.

When the vehicle travels along a new road and is unable to receive a GPS signal, the controller determines that the new road is an underpass based on the altitudes and slope of the travel route. This configuration improves an accuracy of an underpass determination. That is, a short segment of the travel road positioned under the elevated railway can be accurately determined as an underpass. Accordingly, when the vehicle travels along a new road, road data of the new road having a properly set road property can be added to the map data.

### Fourth Embodiment

The following will describe a navigation system 10 according to the fourth embodiment with specifically about a difference from the navigation system 10 according to the first embodiment. The navigation system 10 according to the fourth embodiment determines whether a new road is a parking lot, and adds new road data to the map data.

The generation unit 34 of the navigation system 10 in the fourth embodiment generates the travel route data based on the present position of the vehicle when the present position deviates from a subject road indicated by a corresponding road data by longer than a predetermined distance. The travel route data is a data indicating a travel route of the vehicle, and includes a data indicating the slope of the travel route, a data indicating a switch of a state of a start switch of the vehicle, and a data indicating whether a shift position of the transmission of the vehicle is at a reverse position. The data indicating the slope of the travel route is calculated by the slope calculation unit 32. The start switch activates various devices equipped to the vehicle, such as the engine, or the like. The start switch includes a well-known ignition switch, a push start button, or a power switch.

The determination unit 35 determines whether the state of the start switch of the vehicle has been switched from on to off or off to on between the start point and the end point of a travel route. Further, the determination unit 35 determines whether the shift position of the transmission of the vehicle has been set to reverse. Therefore, the determination unit 35 functions as a vehicle determination unit.

The property setting unit 36 sets a property of the travel route as a parking lot in the travel route data under a condition that the determination unit 35 determines that the state of the start switch of the vehicle has been switched and the shift position of the transmission of the vehicle has been set to the reverse position.

The following will describe a process executed by the navigation system 10 for adding a new road. FIG. 9 is a flowchart showing a process executed by the navigation system 10 for adding a new road.

At S411 and S412, processes similar to the processes of S111 and S112 are carried out. The subroutine process executed at S413 is different from the subroutine process executed at S113. At S413, the generation unit generates the travel route data. The process executed at S413 will be described in detail later.

At S414 and 5415, processes similar to the processes of 5114 and S115 are carried out. At S416, the controller determines whether the new road is a parking lot. When the new road is a parking lot, the controller sets a parking lot flag to the new road. The process executed at S416 will be described in detail later.

At S417, the controller adds the travel route data to the map data stored in the storage device 22 as new road data similar to S120.

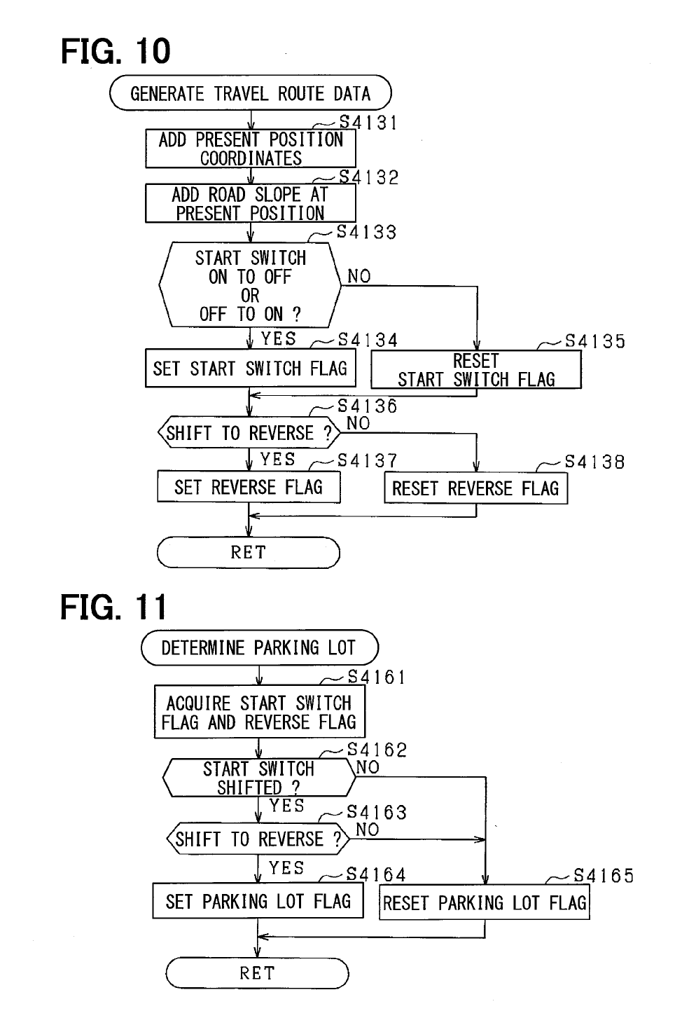

The following will describe a process executed at S413 for generating the travel route data. FIG. 10 shows a subroutine process for generating the travel route data. At S4131, the generation unit 34 adds the coordinates of the present position of the vehicle calculated by the position calculation unit 31 to the travel route data. At S4132, the slope calculation unit 32 calculates the slope of the new road at the present position, and adds the calculated slope of the new road to the travel route data.

At S4133, the controller determines whether the state of the start switch of the vehicle has been switched from on to off or off to on during the travelling of the new road. When the state of the start switch has been switched (YES), the controller sets a start switch flag to the travel route data at S4134. When the state of the start switch has not been switched (NO), the controller resets a start switch flag to the travel route data at S4135.

At S4136, the controller determines whether the shift position of the transmission of the vehicle has been changed to the reverse position during the travelling of the new road. When the shift position of the transmission has been changed to the reverse position (YES), the controller sets a reverse flag to the travel route data at S4137. When the shift position of the transmission has not been changed to the reverse position (NO), the controller resets the reverse flag to the travel route data at S4138.

The above-described process generates the travel route data including a data indicating the travel route of the vehicle, a data indicating the slope of the travel route, a data indicating whether the setting of the start switch has been switched, and a data indicating whether the shift position of the transmission is set to the reverse position. Then, the process returns to S414.

The following will describe a process executed at S416 for determining whether the new road is a parking lot. FIG. 11 shows a subroutine process for determining whether a new road is a parking lot. When the vehicle enters a parking space by travelling in reverse direction and is parked in the parking space, the vehicle exits from the parking space in a forward direction. Conversely, when the vehicle enters the parking space by travelling in the forward direction and is parked in the parking space, the vehicle exits from the parking space in a reverse direction.

Suppose that the vehicle departs from a road indicated by the road data and is parked at a parking lot, and then, returns to the road indicated by the road data. In this case, the state of the start switch is switched during the period from the departure to return. Further, the shift position of the transmission is switched to reverse position during the same period. The subroutine process determines whether the state of the start switch has been changed and the shift position of the transmission has been turned to the reverse during a travelling of the new road. When the state of the start switch has been changed and the shift position of the transmission has been turned to the reverse position, the controller sets a parking flag in the travel route data. The parking lot flag is a flag to be added to the travel route data and indicates that the new road is determined to be a parking lot.

At S4161, the controller acquires a start switch flag and a reverse flag from travel route data generated by the generation unit 34.

At S4162, the controller determines whether the state of the start switch has been changed during the period from a departure from a road to a return to the road. Herein, the road is indicated by the stored road data.

The determination at S4162 is made based on the start switch flag acquired at S4161. When the controller determines at S4162 that the state of the start switch has been changed (YES), the controller carry out a further determination at S4163 based on the reverse flag acquired at S4161. Specifically, at S4163, the controller determines whether the shift position of the transmission has been turned to the reverse position during the period from departure from the road to return to the road. When the controller determines at S4163 that the shift position of the transmission has been turned to the reverse position (YES), the controller determines that the new road is a parking lot and sets a parking lot flag to the new road. When the controller determines at S4162 that the state of the start switch has not been changed (NO), the controller determines that the new road is not a parking lot. Also when the controller determines at S4163 that the shift position of the transmission has not been turned to the reverse position (NO), the controller determines that the new road is not a parking lot. Accordingly, the controller resets a parking lot flag. Then, the process returns to S417.

The above-described fourth embodiment provides the following advantages.

When the vehicle departs from a road indicated by the road data and is parked at a parking lot after the departure, the travel route can be determined to extend through the parking lot. This determination can be made either when the vehicle enters a parking space or when the vehicle exits from the parking space. With this configuration, when the new road is a parking lot, a property of the new road can be set accurately in the travel route data and road data of the new road having a properly set road property can be added to the map data.

The map information processing device according to the fourth embodiment of the present disclosure includes a storage unit 22, a position calculation unit 31, a comparison unit 33, a generation unit 34, a vehicle determination unit 35, and a property setting unit 36. The storage unit 22 stores map data including road data. The road data includes a position and a property of each of multiple roads. The position calculation unit 31 calculates the present position of the vehicle. The comparison unit 33 compares road data with the present position calculated by the position calculation unit 31, and determines whether the present position deviates from a subject road indicated by a corresponding road data by longer than a predetermined distance. The generation unit 34 generates travel route data indicating a travel route of the vehicle based on the present position when the comparison unit 33 determines that the present position of the vehicle deviates from the subject road indicated by the corresponding road data by longer than the predetermined distance. The vehicle determination unit 35 performs determinations when the comparison unit 33 determines that the present position of the vehicle deviates from the subject road indicated by the corresponding road data by longer than the predetermined distance. The vehicle determination unit 35 determines whether the state of the start switch of the vehicle has been changed between the start point and end point of the travel route. Further, the vehicle determination unit 35 determines whether the shift position of the transmission of the vehicle has been turned to the reverse position during the same period. The property setting unit 36 sets a property of the travel route data as a parking lot when the vehicle determination unit 35 determines that the state of the start switch has been changed and the shift position of the transmission has been turned to the reverse position.

The present disclosure may be provided as a program product stored in a non-transitory tangible computer readable storage medium, and the program product may include instructions to be executed by a computer, the instructions for implementing functions of the position calculation unit 31, the comparison unit 33, the generation unit 34, the vehicle determination unit 35, and the property setting unit 36 of the map information processing device according to the present embodiment. In this case, the map information processing device is provided by a portable terminal device, and the instructions are installed in the portable terminal device.

According to the present embodiment, travel route data is generated when the present position of the vehicle is determined to deviate from a road indicated by the road data by longer than a predetermined distance. Further, the controller determines whether the state of the start switch has been changed between the start point and the end point of the travel route of the vehicle, and further determines whether the shift position of the transmission has been turned to the reverse position between the start point and the end point of the travel route of the vehicle. Then a property of the new road is set as the parking lot in the travel route data under a condition that the state of the start switch has been determined to be changed and the shift position of the transmission of the vehicle has been turned to the reverse position.

When the vehicle enters a parking space by a reverse travelling and is parked in the parking space, the vehicle exits from the parking space by forward travelling. Conversely, when the vehicle enters the parking space by the forward travelling, the vehicle exits from the parking space by the reverse travelling. According to the present embodiment, a travel route extends through a parking lot can be determined when a vehicle departs from a road indicated by the road data and is parked in the parking lot. This determination can be made either when the vehicle enters the parking space or when the vehicle exits from the parking space. Consequently, a property of the new road can be accurately set as a parking lot in the travel route data, and road data of the new road having a properly set road property can be added to the map data.

### Other Embodiments

The present disclosure is not limited to the foregoing embodiments and may be modified and embodied as described below:

Information indicating a presence of a high-rise building area may be included in the background data stored in the storage device 22. This configuration enables a determination whether a travel route passes through a high-rise building area based on the information indicating a presence of the high-rise building area.

The map information processing device may be provided by a portable terminal device, such as a smart phone or a tablet terminal device. In this case, the portable terminal includes a GPS receiver, a self-contained navigation sensor, a storage device storing map data, an operation switch group, a display device, an audio input output device, a VICS receiver, and a controller. A computer program for implementing functions of the position calculation unit, the slope calculation unit, the comparison unit, the generation unit, the determination unit, and the property setting unit may be installed in the portable terminal device. With this configuration, the portable terminal device may function as a map information processing device.

The map information processing device may be provided by a self-contained navigation sensor and a portable terminal device, such as a smartphone or a tablet terminal device. In this case, the portable terminal device includes a GPS receiver, a storage device storing map data, an operation switch group, a display device, an audio input output device, a VICS receiver, and a controller.

The map information processing device may be provided by a server and a portable terminal device, such as a smartphone and a tablet terminal device. In this case, the portable terminal device includes a GPS receiver, a self-contained navigation sensor, an operation switch group, a display device, an audio input output device, a VICS receiver, and a controller. The server includes a storage device storing map data and calculates a route to a destination based on the present position calculated by the portable terminal device. In this case, travel route data generated by the portable terminal device is transmitted to the server, and the travel route data is added to map data in the server as a new road.

The map information processing device may be provided by an on-board device and a portable terminal device, such as a smartphone and a tablet terminal device. In this case, the portable terminal device includes a GPS receiver, a self-contained navigation sensor, a storage device storing map data, an operation switch group, a display device, an audio input output device, a VICS receiver, and a controller. The on-board device includes a display device, an audio input output device, and an operation switch group. In this case, an operation made to the operation switch group of the on-board device and an input made to the audio input output device of the on-board device are transmitted to the portable terminal device. The contents displayed on the display device of the portable terminal device are transmitted to the on-board device, and are displayed on the display device of the on-board device.

In the fourth embodiment, when the determination of NO is made at S4163, the process may be carried out as described below. Facility data is read out from the background data and the controller determines whether a travel route indicated by the travel route data passes through the premises of the facility, such as a shopping mall or the like. When the travel route passes through the premises of the facility, the controller sets a parking lot flag. Thus even when the vehicle enters a parking space by the forward travelling and exits from the parking space by the forward travelling, the controller can be determine that the travel route is a parking lot.

The first, the second, or the fourth embodiment may not be provided with the slope calculation unit. The travel route data need not include data indicating the slope of the travel route.

The first embodiment and the second embodiment may be implemented together with each other. With this configuration, the following advantages can be provided. When the present position deviates from a subject road indicated by the corresponding road data and the vehicle travels along a new road which is unable to receive the GPS signal, a property of the travel route can be prevented from being erroneously set as a tunnel or an underpass in the travel route data indicating the new road. When the present position deviates from a subject road indicated by the corresponding road data and the vehicle travels along a new road which is unable to receive the GPS signal, the underpass determination at S219 and the tunnel determination at S119 may be carried out in a predetermined order. That is, a property of the new road may be set as tunnel in the travel route data under a condition that the travel route is not determined as an underpass and does not pass through a high-rise building area.

The first embodiment and the third embodiment may be implemented together with each other. With this configuration, the following advantages can be provided. When the present position deviates from a subject road indicated by the corresponding road data and the vehicle travels along a new road which is unable to receive the GPS signal, a property of the travel route can be prevented from being erroneously set as a tunnel or an underpass in the travel route data indicating the new road. When the present position deviates from a subject road indicated by the corresponding road data and the vehicle travels along a new road and which is unable to receive the GPS signal, the underpass determination at S319 and the tunnel determination at S119 may be carried out in a predetermined order. That is, a property of the new road may be set as tunnel in the travel route data under a condition that the travel route is not determined as an underpass and does not pass through a high-rise building area.

The first embodiment, the second embodiment, and the third embodiment may be implemented together with each other. With this configuration, the following advantages can be provided. When the present position deviates from a subject road indicated by the corresponding road data and the vehicle travels along a new road which is unable to receive the GPS signal, a property of the travel route can be prevented from being erroneously set as a tunnel and a performance for correctly determining a property of the new road as an underpass in the travel route data is increased. When the present position deviates from a subject road indicated by the corresponding road data and the vehicle runs on a new road which is unable to receive the GPS signal, the underpass determinations at S219 and S319 and the tunnel determination at S119 may be carried out in a predetermined order. That is, a property of the new road may be set as tunnel in the travel route data under a condition that the travel route is not determined as an underpass at S219 and S319 and does not pass through a high-rise building area.

The first embodiment, the second embodiment, the third embodiment, and the fourth embodiment may be implemented together with each other. With this configuration, a property of the new road can be prevented from being erroneously set in the travel route data indicating the new road, and properly set a property of the new road, such as the underpass, the tunnel, or the parking lot, can be added to the travel route data.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

1. A map information processing device comprising:
a storage unit storing a map data including a plurality of road data and a plurality of background data, each of the plurality of road data including a position and a property of each of a plurality of roads;
a GPS receiver receiving a plurality of GPS signals from a global positioning system (GPS) satellite and detecting an absolute position of a vehicle;
a self-contained navigation sensor detecting a relative position of the vehicle;
a position calculation unit calculating a present position of the vehicle with reference to the absolute position detected by the GPS receiver and the relative position detected by the self-contained navigation sensor;
a comparison unit comparing the plurality of road data with the present position of the vehicle, which is calculated by the position calculation unit, comparison unit further determining whether the present position of the vehicle deviates from a subject road by longer than a predetermined distance, the subject road being indicated by one of the plurality of road data;
a generation unit generating a travel route data indicating a travel route travelled by the vehicle with reference to the present position of the vehicle when the comparison unit determines that the present position of the vehicle deviates from the subject road by longer than the predetermined distance, the generation unit generating the travel route data to include a reception condition data indicating whether the GPS signals are received by the GPS receiver;
a high-rise building area determination unit determining whether the travel route passes through a high-rise building area with reference to the map data stored in the storage unit and the travel route data when the travel route data includes the reception condition data indicating an absence of a reception of the GPS signals; and
a property setting unit setting a property of the travel route data as a tunnel when the high-rise building area determination unit determines that the travel route does not pass through the high-rise building area.

2. The map information processing device according to claim 1, wherein the plurality of background data includes a position and a height of each of a plurality of buildings.

3. The map information processing device according to claim, further comprising:
an overlap determination unit, wherein
the plurality of background data further includes a position and an altitude of each of a plurality of railroads,
when the travel route data includes the reception condition data indicating the absence of the reception of the GPS signals, the overlap determination unit determines whether the travel route overlaps with an underground railroad with reference to the plurality of background data stored in the storage unit and the travel route data, the underground railroad is one of the plurality of railroads and is located underground, and
when the overlap determination unit determines that the travel route does not overlap with the underground railroad, the property setting unit sets the property of the travel route data as an underpass.

4. The map information processing device according to claim 1, further comprising:
a slope calculation unit calculating a slope of a road corresponding to the travel route; and
an underpass determination unit, wherein each of the plurality of road data further includes an altitude of each of the plurality of roads,
the generation unit generates the travel route data to further include a slope data indicating the slope of the road corresponding to the travel route,
when the travel route data includes the reception condition data indicating the absence of the reception of the GPS signals, the underpass determination unit acquires an altitude of a start point and an altitude of an end point of the road corresponding to the travel route from the plurality of road data stored in the storage unit and the determination unit further determines whether the travel route is an underpass with reference to the altitude of the start point and the altitude of the end point of the road corresponding to the travel route and the slope data indicating the slope of the road corresponding to the travel route, and
the property setting unit sets the property of the travel route data as an underpass when the underpass determination unit determines that the travel route is the underpass.

5. The map information processing device according claim 1, further comprising:
a vehicle determination unit, when the comparison unit determines that the present position of the vehicle deviates from the subject road by longer than the predetermined distance, the vehicle determination unit determining whether a state of a start switch of the vehicle is changed during a travel of the vehicle from a start point to an end point of the travel route and further determining whether a shift position of a transmission of the vehicle is turned to a reverse position during the travel of the vehicle from the start point to the end point of the travel route,
wherein, when the vehicle determination unit determines that the state of the start switch is changed and the shift position of the transmission of the vehicle is turned to the reverse position, the property setting unit sets the property of the travel route data as a parking lot.

6. A non-transitory tangible computer readable storage medium storing a program product, the program product comprising instructions to be executed by a computer, the instructions for implementing functions of the position calculation unit, the, comparison unit, the generation unit, the high-rise building area determination unit and the property setting unit of the map information processing device according to claim 1, wherein
the map information processing device is provided by a portable terminal device, and
the instructions are installed in the portable terminal device.

7. A map information processing device comprising:
a storage unit storing a map data including a plurality of road data and a plurality of background data, each of the plurality of road data including a position and a property of each of a plurality of roads, and the plurality of background data including a position and an altitude of each of a plurality of railroads;
a GPS receiver receiving a plurality of GPS signals from a global positioning system (GPS) satellite and detecting an absolute position of a vehicle;
a self-contained navigation sensor detecting a relative position of the vehicle;
a position calculation unit calculating a present position of the vehicle with reference to the absolute position of the vehicle detected by the GPS receiver and the relative position of the vehicle detected by the self-contained navigation sensor;
a comparison unit comparing the plurality of road data with the present position of the vehicle, which is calculated by the position calculation unit, the comparison unit further determining whether the present position of the vehicle deviates from a subject road by longer than a predetermined distance, the subject road being indicated by one of the plurality of road data;
a generation unit generating a travel route data indicating a travel route travelled by the vehicle with reference to the present position of the vehicle when the comparison unit determines that the present position of the vehicle deviates from the subject road by longer than the predetermined distance, the generation unit generating the travel route data to include a reception condition data indicating whether the GPS signals are received by the GPS receiver;
an overlap determination unit determining whether the travel route overlaps with an underground railroad with reference to the map data stored in the storage unit and the travel route data when the travel route data includes the reception condition data indicating an absence of a reception of the GPS signals, the underground railroad being one of the plurality of railroads and being located underground; and
a property setting unit setting a property of the travel route data as an underpass when the overlap determination unit determines that the travel route does not overlap with the underground railroad.

8. A non-transitory tangible computer readable storage medium storing a program product, the program product comprising instructions to be executed by a computer, the instructions for implementing functions of the position calculation unit, the comparison unit, the generation unit, the overlap determination unit, and the property setting unit of the map information processing device according to claim 7, wherein
the map information processing device is provided by a portable terminal device, and
the instructions are installed in the portable terminal device.

9. A map information processing device comprising:
a storage unit storing a map data including a plurality of road data, each of the plurality of road data including a position, an altitude, and a property of each of a plurality of roads;
a GPS receiver receiving a plurality of GPS signals from a global positioning system (GPS) satellite and detecting an absolute position of a vehicle;
a self-contained navigation sensor detecting a relative position of the vehicle;
a position calculation unit calculating a present position of the vehicle with reference to the absolute position detected by the GPS receiver and the relative position detected by the self-contained navigation sensor;
a slope calculation unit calculating a slope of a road corresponding to a travel route travelled by the vehicle;
a comparison unit comparing the plurality of road data with the present position of the vehicle, which is calculated by the position calculation unit, the comparison unit further determining whether the present position of the vehicle deviates from a subject road by longer than a predetermined distance, the subject road being indicated by one of the plurality of road data;
a generation unit generating a travel route data indicating the travel route with reference to the present position of the vehicle when the comparison unit determines that the present position of the vehicle deviates from the subject road by longer than the predetermined distance, the generation unit generating the travel route data to include a reception condition data indicating whether the GPS signals are received by the GPS receiver and a slope data that indicates the slope of the road corresponding to the travel route;
an underpass determination unit, when the travel route data includes the reception condition data indicating an absence of a reception of the GPS signals, the underpass determination unit acquiring an altitude of a start point and an altitude of an end point of the road corresponding to the travel route from the plurality of road data stored in the storage unit and determining whether the travel route is an underpass with reference to the altitude of the start point and the altitude of the end point of the road corresponding to the travel route and the slope data, which is included in the travel route data and indicates the slope of the road corresponding to the travel route; and
a property setting unit setting a property of the travel route data as an underpass when the underpass determination unit determines that the travel route is the underpass.

10. A non-transitory tangible computer readable storage medium storing a program product, the program product comprising instructions to be executed by a computer, the instructions for implementing functions of the position calculation unit, the slope calculation unit, the comparison unit, the generation unit, the underpass determination unit, and the property setting unit of the map information processing device according to claim 9, wherein
the map information processing device is provided by a portable terminal device, and
the instructions are installed in the portable terminal device.

11. The map information processing device according to claim 9,
wherein the comparison unit increases the predetermined distance with a reduction in a strength of the GPS signals received by the GPS receiver.

12. A map information processing device comprising:
a storage unit storing a map data including a plurality of road data, each of the plurality of road data including a position and a property of each of a plurality of roads;
a position calculation unit calculating a present position of a vehicle;
a comparison unit comparing the plurality of road data with the present position of the vehicle, which is calculated by the position calculation unit, the comparison unit further determining whether the present position of the vehicle deviates from a subject road by longer than a predetermined distance, the subject road being indicated by one of the plurality of road data;
a generation unit generating a travel route data indicating a travel route travelled by the vehicle with reference to the present position of the vehicle when the comparison unit determines that the present position of the vehicle deviates from the subject road by longer than the predetermined distance;
a vehicle determination unit, when the comparison unit determines that the present position of the vehicle deviates from the subject road by longer than the predetermined distance, the vehicle determination unit determining whether a state of a start switch of the vehicle is changed during a travel of the vehicle from a start point to an end point of the travel route and further determining whether a shift position of a transmission of the vehicle is turned to a reverse position during the travel of the vehicle from the start point to the end point of the travel route; and
a property setting unit setting a property of the travel route data as a parking lot when the vehicle determination unit determines that the state of the start switch is changed and the shift position of the transmission of the vehicle is turned to the reverse position.

13. A non-transitory tangible computer readable storage medium storing a program product, the program product comprising instructions to be executed by a computer, the instructions for implementing functions of the position calculation unit, the comparison unit, the generation unit, the vehicle determination unit, and the property setting unit of the map information processing device according to claim 12, wherein
the map information processing device is provided by a portable terminal device, and
the instructions are installed in the portable terminal device.

14. The map information processing device according to claim 1,
wherein the comparison unit increases the predetermined distance with a reduction in a strength of the GPS signals received by the GPS receiver.

15. The map information processing device according to claim 7,
wherein the comparison unit increases the predetermined distance with a reduction in a strength of the GPS signals received by the GPS receiver.
